(19) United States
(12) Patent Application Publication
(10) Pub. No.: US 2005/0180446 A1
(43) Pub. Date: Aug. 18, 2005

(54) Telecommunications surveillance

(75) Inventors: Dan Flowers, Charlton, MA (US); Sajjad Hussain, Shrewsbury, MA (US); Ravi Valmikam, Westborough, MA (US)

Correspondence Address: Fogg and Associates, LLC, P.O. Box 581339, Minneapolis, MN, 55458-1339, US

(73) Assignee: ADC Broadband Access Systems, Inc.

(21) Appl. No.: 10/768,425

(22) Filed: Jan. 30, 2004

(51) Int. Cl. H04L 12/54

(52) U.S. Cl. 370/428

(57) ABSTRACT

A method enables the electronic surveillance of telecommunications transmissions in compliance with the Communications Assistance for Law Enforcement Act (CALEA) standards. The method involves receiving a data packet intended for transmission to a recipient and storing the data packet in an available buffer. The data packet is then transmitted to the intended recipient and, if it is flagged for surveillance, the data packet is also transmitted to law enforcement officials. This is carried out by retransmitting the original data packet with a new header segment, without creating a copy of the data packet. Once the data packet has been transmitted to the intended recipient and to law enforcement officials (if necessary), the buffer storing the data packet is released such that other data packets can be stored therein.

### TECHNICAL FIELD

The present invention relates generally to the field of telecommunications and, in particular, to systems and methods for conducting surveillance of transmissions over telecommunications networks.

### BACKGROUND

With the advent of digital telephony equipment, such as Internet protocol (IP) phones, the use of digital signaling in connection with telephonic transmissions has become widespread. As a result, some of the techniques used historically by law enforcement officials to conduct electronic surveillance of telephonic communications have become outdated. Legislation recently enacted by Congress (Public Law 103-414, the Communications Assistance for Law Enforcement Act (CALEA)) sets forth new standards for conducting electronic surveillance of digital telecommunications transmissions.

A number of telecommunications service providers have implemented systems and methods for conducting electronic surveillance of telecommunications transmissions in compliance with the standards of CALEA. Many of these systems and methods suffer from a number of drawbacks, such as unnecessary complexity and expense. Accordingly, a need exists for a simpler, more efficient approach for conducting electronic surveillance in compliance with the CALEA standards.

### SUMMARY OF THE INVENTION

The above-mentioned drawbacks associated with existing systems and methods for conducting electronic surveillance are addressed by embodiments of the present invention and will be understood by reading and studying the following specification.

In one embodiment, a method for conducting surveillance of transmissions over one or more telecommunications networks comprises receiving a data packet intended for transmission to a first recipient and storing the data packet in a buffer. The method further comprises transmitting the data packet to the first recipient, determining whether the data packet is flagged for surveillance and, if so, transmitting the data packet to a second recipient. The method further comprises releasing the buffer such that another data packet can be stored therein.

In another embodiment, a method for transmitting data packets to a plurality of recipients comprises storing a data packet in a buffer. The data packet comprises a header segment having a first destination address. The method further comprises transmitting the data packet to a recipient at the first destination address, replacing the first destination address in the header segment of the data packet with a second destination address, and transmitting the data packet to a recipient at the second destination address. After the data packet is transmitted to the recipient at the second destination address, the method comprises releasing the buffer such that another data packet can be stored therein.

In another embodiment, a method for creating hash entries in a hash entry table comprises receiving an instruction to create a new hash entry in hash entry table stored in a memory of a cable modem termination system and generating a hash entry comprising information about an end-to-end connection between a subscriber using an IP phone and another party. The method further comprises determining whether transmissions to or from the IP phone are subject to surveillance and, if so, adding surveillance information to the hash entry.

In another embodiment, a cable modem termination system comprises a buffer configured to store data packets and a memory configured to store a hash entry table. The hash entry table includes information regarding whether data packets should be marked for surveillance. The cable modem termination system further comprises a processor coupled to the buffer and to the memory configured to transmit data packets to their intended recipients. The processor comprises a surveillance module configured to determine whether a given data packet is marked for surveillance and, if so, transmit the data packet to a surveilling recipient without creating a copy of the data packet.

In another embodiment, a data packet comprises a data segment containing content to be transmitted from a sender to an intended recipient, a header segment including address and control information, and a surveillance flag indicating whether the data packet is marked for surveillance. If the surveillance flag indicates that the data packet is marked for surveillance, the data segment of the data packet is transmitted to both the intended recipient and another recipient.

In another embodiment, a machine readable medium comprises machine readable instructions for causing a computer to perform a method. The method comprises receiving a data packet intended for transmission to a first recipient, storing the data packet in a buffer, and transmitting the data packet to the first recipient. The method further comprises determining whether the data packet is flagged for surveillance and, if so, transmitting the data packet to a second recipient. The method further comprises releasing the buffer such that another data packet can be stored therein.

Other embodiments are described and claimed.

### BRIEF DESCRIPTION OF THE DRAWINGS

FIG. 1 is a block diagram of a telecommunications system in accordance with one embodiment of the present invention.

FIG. 2 is a block diagram of one embodiment of the cable modem termination system illustrated in FIG. 1.

FIG. 3 is a flow chart illustrating a process for creating hash entries in a hash entry table in accordance with one embodiment of the present invention.

FIG. 4 is a flow chart illustrating a process for transmitting data packets to and from subscribers in accordance with one embodiment of the present invention.

### DETAILED DESCRIPTION OF THE PREFERRED EMBODIMENT

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical, and electrical changes may be made without departing from the spirit and scope of the present invention. The following detailed description is, therefore, not to be taken in a limiting sense.

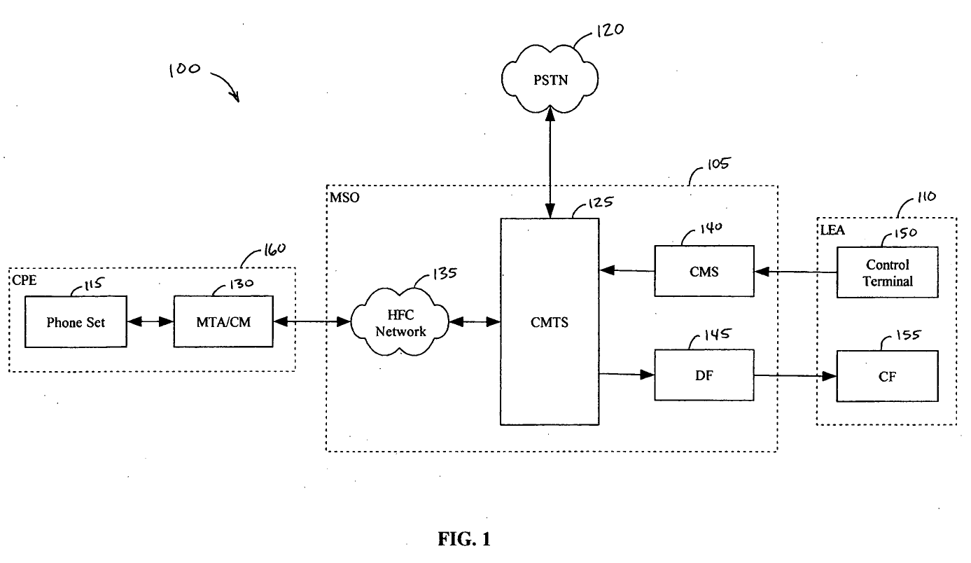

FIG. 1 is a block diagram illustrating a telecommunications system 100 in accordance with one embodiment of the present invention. In the illustrated embodiment, the telecommunications system 100 comprises multisystem operator (MSO) equipment 105 in communication with law enforcement agency (LEA) equipment 110 and with customer premises equipment (CPE) 160. The MSO equipment 105 is also in communication with one or more telecommunications networks 120, such as, for example, a public switched telephone network (PSTN).

As illustrated in FIG. 1, the MSO equipment 105 comprises a cable modem termination system (CMTS) 125 in communication with the PSTN 120. The CMTS 125 is also in communication with a call management server (CMS) 140 and a delivery function (DF) module 145. The MSO equipment 105 further comprises one or more telecommunications networks 135, such as, for example, a hybrid fiber-coax (HFC) network, through which the CMTS 125 is in communication with the CPE 160.

The CPE 160 comprises a phone set 115 coupled to a terminal 130 comprising a multimedia terminal adapter (MTA) and a cable modem (CM). The combination of the phone set 115 and the MTA are often referred to collectively as an Internet protocol (IP) phone. While in the illustrated embodiment, the MTA and CM are shown as a single terminal 130, those of ordinary skill in the art will understand that the MTA and CM may comprise separate terminals. The LEA equipment 110 comprises a control terminal 150 in communication with the CMS 140, and a collection function (CF) module 155 in communication with the DF 145.

In operation, when a subscriber initiates or receives a transmission (e.g., a telephone call) using an IP phone, the MSO equipment 105 establishes a communication link between the subscriber and the other party to the transmission. The parties can then exchange information by sending and receiving transmissions, often in the form of data packets, along the communication link through the MSO equipment 105. The establishment of communication links and the transmission of information along such communication links are standard functions that can be performed by the MSO equipment 105 using a variety of devices and methods that are well-known to those of ordinary skill in the art.

In addition to performing these standard functions, the MSO equipment 105 also advantageously enables law enforcement officials to monitor transmissions made to or from a particular IP phone. For example, once the legal requirements for conducting electronic surveillance on a given IP phone have been satisfied, the MSO equipment 105 can be configured to monitor calls involving that IP phone. Such a configuration can be established by creating an electronic surveillance protocol (ESP) object identifying the IP phone in the CMS 140. In some embodiments, law enforcement personnel can create an ESP object in the CMS 140 by sending an appropriate instruction from the control terminal 150. When a call is made to or from an IP phone designated for surveillance, the data packets transmitted to and from the IP phone are also transmitted to law enforcement officials through the DF 145 and the CF 155.

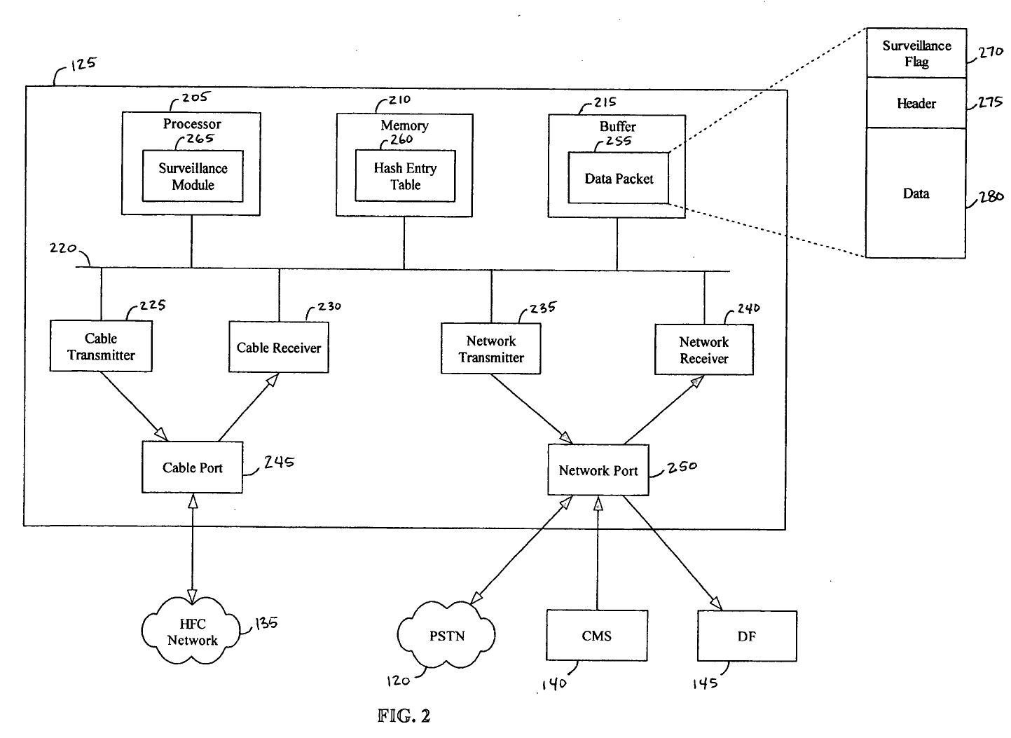

FIG. 2 is a block diagram of one embodiment of the CMTS 125 illustrated in FIG. 1. In the illustrated embodiment, the CMTS 125 comprises a processor 205 coupled to a memory 210 and a buffer 215 via a data bus 220. The processor 205, memory 210, and buffer 215 are also coupled to a cable transmitter 225 and cable receiver 230 and to a network transmitter 235 and network receiver 240 via the data bus 220. The cable transmitter 225 and cable receiver 230 are coupled to a cable port 245 which, in turn, is coupled to a telecommunications network 135, such as, for example, an HFC network. The network transmitter 235 and network receiver 240 are coupled to a network port 250 which, in turn, is coupled to the CMS 140, the DF 145, and a telecommunications network 120, such as, for example, a PSTN. Those of ordinary skill in the art will understand that the CMTS 125 may comprise different or additional components than those illustrated in FIG. 2. For example, although only a single buffer 215 is shown, the CMTS 125 typically comprises numerous buffers 215.

The CMTS 125 enables data packets 255 to be transmitted to and from a subscriber using an IP phone, as described above. For example, when a telephone call is initiated with a subscriber using an IP phone, the CMTS 125 creates a communication link between the subscriber and the other party to the telephone call, and generates a new hash entry in the hash entry table 260 stored in the memory 210. Each hash entry contains information, such as, for example, network address information, about the end-to-end connection between the subscriber and the other party to the telephone call.

When the subscriber is transmitting information (e.g., speaking during a telephone conversation), the cable receiver 230 of the CMTS 125 receives the data via the HFC network 135 and the cable port 245. As data packets 255 are received, they are stored in an available buffer 215. As illustrated in FIG. 2, the data packets 255 typically comprise a plurality of segments, such as, for example, a surveillance flag segment 270, a header segment 275, and a data segment 280. Each data packet 255 is then transmitted to its intended recipient via the appropriate transmitter, port, and telecommunications network using techniques that are well-known to those of skill in the art.

For example, if the header segment 275 of a data packet 255 indicates that it is addressed to an individual using an IP phone coupled to the HFC network 130, then the CMTS 125 transmits the data packet 255 to the recipient via the cable transmitter 225, the cable port 245, and the HFC network 135. On the other hand, if a data packet 255 is addressed to an individual using a plain old telephone service (POTS) terminal coupled to the PSTN 120, then the CMTS 125 transmits the data packet 255 to the recipient via the network transmitter 235, the network port 250, and the PSTN 120.

When the subscriber is receiving information (e.g., listening during a telephone conversation), the CMTS 125 receives the data intended for the subscriber via the appropriate telecommunications network, port, and receiver. This data is then packetized, stored in an available buffer 215, and transmitted to the subscriber via the cable transmitter 225, cable port 245, and the HFC network 135 using well-known techniques, as described above.

When a subscriber initiates or receives a call, the surveillance module 265 of the processor 205 determines whether the subscriber's IP phone has been designated for surveillance by law enforcement officials. In some embodiments, the surveillance module makes this determination by referencing the CMS 140 to determine whether an ESP object is associated with the subscriber's IP phone. If a subscriber's IP phone is subject to surveillance, information about the surveillance of the telephone call is added to the new hash entry corresponding to the call in the hash entry table 260. Then, as data packets 255 are transmitted to and from the subscriber during the telephone call, the surveillance module 265 sets the surveillance flag 270 of the data packets 255 to a predetermined value, indicating that the data packets 255 are subject to surveillance.

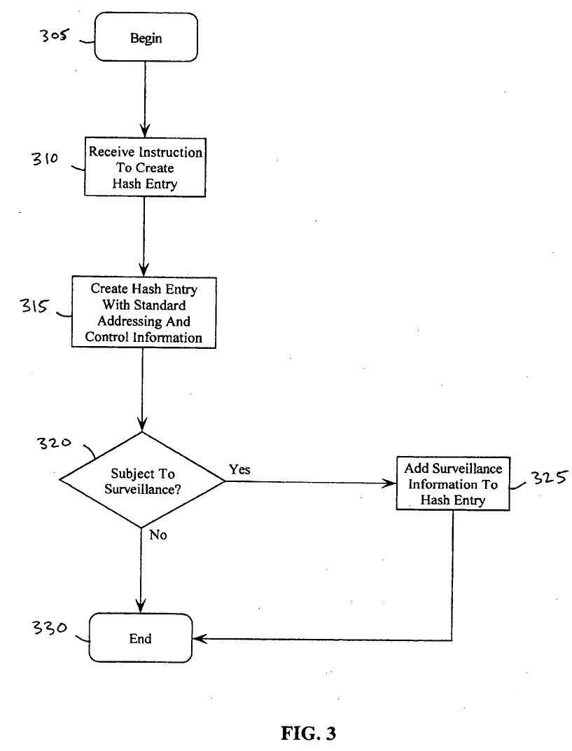

FIG. 3 is a flow chart illustrating a process for creating hash entries in a hash entry table 260 in accordance with one embodiment of the present invention. In a first step 305, the process begins. In a next step 310, an instruction to create a new hash entry in the hash entry table 260 is received. This step is typically performed when a telephone call is initiated with a subscriber using an IP phone. In a next step 315, a hash entry corresponding to the telephone call is created with standard addressing and control information and stored in the hash entry table 260.

In a following step 320, a determination is made as to whether the telephone call corresponding to the new hash entry is subject to surveillance. In some embodiments, this determination is made by referencing the CMS 140 to determine whether an ESP object is associated with the IP phone making or receiving the call, as described above. If the telephone call is subject to surveillance, then in a step 325, surveillance information is added to the hash entry created during step 315. This surveillance information may include a variety of data, such as, for example, the destination address of the appropriate DF 145. Once the surveillance information has been added to the hash entry (if necessary), then in a step 330, the process ends.

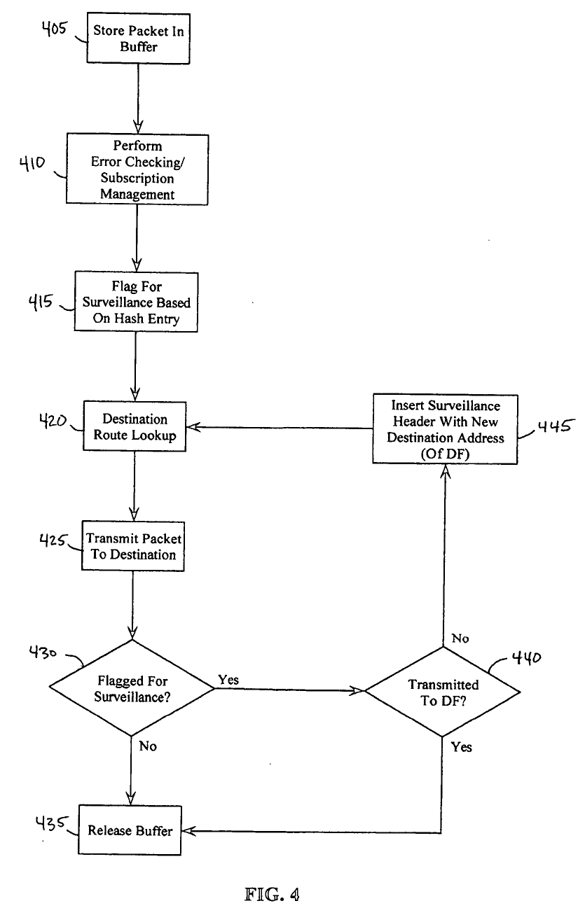

FIG. 4 is a flow chart illustrating a process for transmitting data packets 255 to and from subscribers in accordance with one embodiment of the present invention. In a first step 405, a data packet 255 is stored in an available buffer 215, as described above. In a next step 410, standard error checking and subscription management functions are performed. This step may include a variety of operations, such as, for example, confirming that transmission of the data packet 255 will not violate any conditions (e.g., bandwidth limitations) of the underlying subscription agreement. In a step 415, the hash entry associated with the data packet 255 is referenced and, if it indicates that the telephone call is subject to surveillance, the data packet 255 is flagged for surveillance, as described above.

In a next step 420, the destination route lookup function for the data packet 255 is performed. The information used to perform this function is typically included in the header segment 275 of the data packet 255. After the destination route lookup function has been performed, in a step 425, the data packet 255 is transmitted to the appropriate destination. In a following step 430, a determination is made as to whether the data packet 255 is flagged for surveillance. In some embodiments, this determination is made by referencing the surveillance flag segment 270 of the data packet 255.

If the data packet 255 is not flagged for surveillance, then in a step 435, the buffer 215 storing the data packet 255 is released such that another data packet 255 can be stored in the buffer 215. On the other hand, if the data packet 255 is flagged for surveillance, then the buffer 215 storing the data packet 255 is not released. Rather, in a step 440, a determination is made as to whether the data packet 255 has been transmitted to the DF 145. If not, then in a step 445, the header segment 275 of the data packet 255 is replaced with a new surveillance header, which includes the destination address of the DF 145. Then steps 420 and 425 are repeated, and the data packet 255 is retransmitted to the DF 145 and, in turn, to the CF 155 via the network transmitter 235 and the network port 250.

Following this retransmission of the data packet 255, the determination made during step 440 indicates that the data packet 255 has been transmitted to the DF 145. As a result, processing continues to step 435, during which the buffer 215 storing the data packet 255 is released, as described above.

The transmission of data packets 255 using the systems and methods described above presents a number of distinct advantages over previous approaches. For example, the systems described above enable law enforcement officials to monitor transmissions to and from IP phones using conventional MSO equipment 105, thereby advantageously avoiding the need for specialized equipment. In addition, the methods described above enable the transmission of a data packet 255 to multiple parties (e.g., an intended recipient and a law enforcement official) without duplicating the data packet 255, thereby advantageously enabling service providers to conserve storage space and processing overhead. These and other advantages will become apparent to those of skill in the art in light of the present disclosure.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

1. A method for conducting surveillance of transmissions over one or more telecommunications networks, the method comprising:
receiving a data packet intended for transmission to a first recipient;
storing the data packet in a buffer;
transmitting the data packet to the first recipient;
determining whether the data packet is flagged for surveillance and, if so, transmitting the data packet to a second recipient; and
releasing the buffer such that another data packet can be stored therein.

2. The method of claim 1, further comprising, before transmitting the data packet to the first recipient, determining whether the data packet should be flagged for surveillance.

3. The method of claim 2, wherein determining whether the data packet should be flagged for surveillance comprises determining whether the data packet is being transmitted to or from a telecommunications device associated with an electronic surveillance protocol (ESP) object.

4. The method of claim 3, wherein the telecommunications device comprises an IP phone.

5. The method of claim 1, wherein the data packet is received over a hybrid fiber-coax (HFC) network.

6. The method of claim 1, wherein the data packet is received over a public switched telephone network (PSTN).

7. The method of claim 1, wherein the data packet comprises a surveillance flag segment, a header segment, and a data segment.

8. The method of claim 1, wherein the data packet is transmitted to the first recipient over a HFC network.

9. The method of claim 1, wherein the data packet is transmitted to the first recipient over a PSTN.

10. The method of claim 1, wherein determining whether the data packet is flagged for surveillance comprises referencing a surveillance flag segment of the data packet.

11. The method of claim 1, wherein transmitting the data packet to the second recipient comprises transmitting the data packet to a delivery function module (DF).

12. A method for transmitting data packets to a plurality of recipients, the method comprising:
storing a data packet in a buffer, wherein the data packet comprises a header segment having a first destination address;
transmitting the data packet to a recipient at the first destination address;
replacing the first destination address in the header segment of the data packet with a second destination address;
transmitting the data packet to a recipient at the second destination address; and
after transmitting the data packet to the recipient at the second destination address, releasing the buffer such that another data packet can be stored therein.

13. The method of claim 12, wherein the recipient at the first destination address is the intended recipient of the data packet, and the recipient at the second destination address is a law enforcement official.

14. The method of claim 12, wherein transmitting the data packet to the recipient at the first destination address comprises transmitting the data packet over a HFC network.

15. The method of claim 12, wherein transmitting the data packet to the recipient at the first destination address comprises transmitting the data packet over a PSTN.

16. The method of claim 12, wherein the data packet further comprises a surveillance flag segment and a data segment.

17. A method for creating hash entries in a hash entry table comprising:
receiving an instruction to create a new hash entry in hash entry table stored in a memory of a cable modem termination system (CMTS);
generating a hash entry comprising information about an end-to-end connection between a subscriber using an IP phone and another party;
determining whether transmissions to or from the IP phone are subject to surveillance and, if so, adding surveillance information to the hash entry.

18. The method of claim 17, wherein the instruction to create a new hash entry is received when a telephone call is initiated with a subscriber using an IP phone.

19. The method of claim 17, wherein determining whether transmissions to or from the IP phone are subject to surveillance comprises determining whether an ESP object is associated with the IP phone.

20. The method of claim 17, wherein the surveillance information comprises the destination address of a DF.

21. A CMTS comprising:
a buffer configured to store data packets;
a memory configured to store a hash entry table, wherein the hash entry table includes information regarding whether data packets should be marked for surveillance;
a processor coupled to the buffer and to the memory configured to transmit data packets to their intended recipients,
wherein the processor comprises a surveillance module configured to determine whether a given data packet is marked for surveillance and, if so, transmit the data packet to a surveilling recipient without creating a copy of the data packet.

22. The CMTS of claim 21, further comprising a cable port in communication with the processor through a cable receiver and a cable transmitter, wherein the cable port is configured to receive transmissions over a HFC network.

23. The CMTS of claim 21, further comprising a network port in communication with the processor through a network receiver and a network transmitter, wherein the network port is configured to receive transmissions over a PSTN.

24. The CMTS of claim 21, wherein each data packet comprises a surveillance flag segment, a header segment, and a data segment.

25. The CMTS of claim 21, wherein the surveillance module is configured to determine whether data packets transmitted to or from an IP phone should be marked for surveillance.

26. The CMTS of claim 25, wherein the surveillance module determines whether data packets should be marked for surveillance by determining whether an ESP object is associated with the IP phone.

27. The CMTS of claim 21, wherein the surveillance module determines whether a data packet is marked for surveillance by referencing a surveillance flag segment of the data packet.

28. A data packet comprising:
a data segment containing content to be transmitted from a sender to an intended recipient;
a header segment including address and control information; and
a surveillance flag indicating whether the data packet is marked for surveillance;
wherein, if the surveillance flag indicates that the data packet is marked for surveillance, the data segment of the data packet is transmitted to both the intended recipient and another recipient.

29. A machine readable medium comprising machine readable instructions for causing a computer to perform a method comprising:
receiving a data packet intended for transmission to a first recipient;
storing the data packet in a buffer;
transmitting the data packet to the first recipient;
determining whether the data packet is flagged for surveillance and, if so, transmitting the data packet to a second recipient; and
releasing the buffer such that another data packet can be stored therein.

30. The machine readable medium of claim 29, wherein the method further comprises, before transmitting the data packet to the first recipient, determining whether the data packet should be flagged for surveillance.

31. The machine readable medium of claim 30, wherein determining whether the data packet should be flagged for surveillance comprises determining whether the data packet is being transmitted to or from a telecommunications device associated with an ESP object.

32. The machine readable medium of claim 31, wherein the telecommunications device comprises an IP phone.

33. The machine readable medium of claim 29, wherein the data packet is received over a HFC network.

34. The machine readable medium of claim 29, wherein the data packet is received over a PSTN.

35. The machine readable medium of claim 29, wherein the data packet comprises a surveillance flag segment, a header segment, and a data segment.

36. The machine readable medium of claim 29, wherein the data packet is transmitted to the first recipient over a HFC network.

37. The machine readable medium of claim 29, wherein the data packet is transmitted to the first recipient over a PSTN.

38. The machine readable medium of claim 29, wherein determining whether the data packet is flagged for surveillance comprises referencing a surveillance flag segment of the data packet.

39. The machine readable medium of claim 29, wherein transmitting the data packet to the second recipient comprises transmitting the data packet to a DF.
